(19) United States
(12) Patent Application Publication
(10) Pub. No.: US 2025/0308089 A1
(43) Pub. Date: Oct. 2, 2025

(54) DEVICE AND METHOD FOR ASSISTING IN THE LOCALIZATION OF CELESTIAL OBJECTS

(71) Applicant: UNISTELLAR, Marseille (FR)

(72) Inventors: Antonin BOROT, Marseille (FR); Arnaud MALVACHE, Marseille (FR); Laurent MARFISI, Marseille (FR); Erik VANHOUTTE, Marseille (FR); Tom VERGNOL, Marseille (FR); Malo GERMOND, Marseille (FR)

(73) Assignee: UNISTELLAR, Marseille (FR)

(21) Appl. No.: 19/089,313

(22) Filed: Mar. 25, 2025

(30) Foreign Application Priority Data
Mar. 26, 2024 (FR) FR2403054

(51) Int. Cl. G06T 11/00; G02B 27/01; G06T 7/73; G06T 7/80

(52) U.S. Cl. CPC G06T 11/00; G02B 27/0101; G06T 7/74; G06T 7/80; G02B 2027/0141; G06T 2200/24

(57) ABSTRACT

A device for assisting the location of celestial objects, including binoculars equipped with a combination of sensors measuring horizontal coordinates of a celestial observation region, the combination including: a magnetometer, an accelerometer, and a gyroscope; a geolocation module for determining position, date, and observation-time data; a processing module determining equatorial celestial coordinates of the observation zone using the measurements from the combination of sensors and the data from the geolocation module; an interface for selecting a celestial object in a database containing equatorial celestial coordinates of selectable celestial objects; a comparison module calculating a difference between the coordinates determined by the processing module and the coordinates of the object selected; and a guidance module generating a guidance module dependent on the difference calculated.

### TECHNICAL FIELD

One object of the invention is a device and a method for assisting the localization of celestial objects. Another object of the invention is a computer program for implementing the method.

The invention relates in particular to the field of techniques for assisting the location of celestial objects, such as stars, planets, comets, asteroids, constellations, galaxies, satellites, etc.

### BACKGROUND

At the present time, to observe celestial objects in the sky, more and more amateurs are using binoculars with a fixed focal length, i.e. without zoom (unlike the telescopes dedicated to astronomy). Binoculars have the advantage of being able to be more easily transported and handled than telescopes, but locating celestial objects in the sky is however more complex, in particular because of their limited resolution, their restricted field of vision, their increased sensitivity to light interference, and their lack of stability.

There is therefore a need for assisting the user in the location of celestial objects. Normally, the precise location of celestial objects requires the use of sophisticated observation instruments such as telescopes with electronic location systems, for example of the type described in the patent document EP3494430A1.

However, these systems can be expensive and bulky, require a relatively high computing the load, and are in any event difficult to transpose into binoculars, unless complex modifications are made.

The patent document US2016124210 proposes an assistance device adaptable to binoculars. A mechanical support makes it possible to hold a smartphone on the binoculars. The Skyview® computer application installed in the smartphone assists the user in the location of celestial objects by using the measurement data of a GPS integrated in said smartphone. However, since a smartphone is relatively bulky, it will be understood that handling the binoculars equipped with the smartphone becomes difficult. Furthermore, locating celestial objects remains in practice imprecise.

Another device for assisting the location of celestial objects known from the prior art is described in the patent document IT202100013925.

The invention aims to remedy all or some of the aforementioned drawbacks. In particular, one objective of the invention is to propose a location-assistance device that is dedicated to binoculars, and the location precision of which is improved compared with the solutions of the prior art. Another objective of the invention is to propose a location-assistance technique that is simple, reliable, and robust, and the computing load of which is reduced.

### SUMMARY

The solution proposed by the invention is a device for assisting the location of celestial objects, comprising:
binoculars comprising an optical system and a display module and a display module installed so as to display information in an image plane of said optical system, said binoculars being equipped with at least one combination of sensors configured to measure horizontal coordinates of a celestial observation region, said combination of sensors comprising: at least one magnetometer, an accelerometer, and a gyroscope;
a geolocation module for determining position, date, and observation-time data;
a processing module for determining equatorial celestial coordinates of the celestial observation region using the measurements from the combination of sensors and the data from the geolocation module, said processing module being configured to generate and/or select information to be displayed on the display module;
a database containing equatorial celestial coordinates of selectable celestial objects;
a user interface for selecting a celestial object in the database;
a comparison module for calculating a difference between the equatorial celestial coordinates determined by the processing module and the celestial coordinates of the celestial object selected;
a guidance module for generating a guidance signal at least one characteristic of which is dependent on the difference calculated by the comparison module.

The present invention offers a device for assisting the location of celestial objects that is easy to use and economical, with increased precision compared with the solutions of the prior art and which can easily be used with conventional binoculars, by amateur observers/users who do not necessarily have profound knowledge of astronomy or specialized equipment.

Further advantageous features of the invention are listed below. Each of these features may be considered alone or in combination with the remarkable features defined above. Each of these features contributes, where applicable, to the solving of specific technical problems defined above in the description and in which the other features defined above do not necessarily participate. The following features can thus be the subject, where applicable, of one or more divisional patent applications:

According to one embodiment, the combination of sensors comprises at least two magnetometers and/or the binoculars are equipped with several combinations of sensors.

According to one embodiment, the measurements from the combination or combinations of sensors used for determining the equatorial celestial coordinates of the celestial observation region comprise the mean or the median of the magnetometer measurements.

According to one embodiment, the processing module is configured to take the mean or the median of the real-time measurements of the combination of sensors to determine the equatorial celestial coordinates of the celestial observation region.

According to one embodiment, the processing module is configured to: a) receive measurements from the magnetometer; b) access a world magnetic model (WMM) representing the terrestrial magnetic field; c) apply corrections to the measurements from the magnetometer on the basis of the information obtained from the WMM to calculate corrected measurements; d) use the corrected measurements to determine the equatorial celestial coordinates of the celestial observation region.

According to another embodiment, the display module is a screen installed in the image plane so as to only partly obstruct the image of the celestial observation region observed through an eyepiece of the optical system.

According to another embodiment, the display module is a semi-reflective screen installed in the image plane so that the information displayed is superimposed on the image of the celestial observation region observed through an eyepiece of the optical system.

According to another embodiment, the display module is in the form of a screen projecting a digital image of the information in the direction of a semi-reflective plate, said plate being arranged in the optical system so that said digital image is superimposed on the image of the celestial observation region observed through an eyepiece of said optical system.

According to one embodiment, the guidance module is configured to generate the guidance signal if the difference calculated is less than or equal to a first predetermined threshold value.

According to one embodiment, the guidance module is configured to cease the generation of the guidance signal when the difference calculated by the comparison module remains below or equal to a second predetermined threshold value during a predetermined period.

According to one embodiment, the sensors are housed in a housing designed to be mounted on the binoculars.

According to one embodiment, the geolocation module, the processing module, the comparison module, and the guidance module are integrated in a smartphone or a tablet.

According to another embodiment, the sensors, the geolocation module, the processing module, the comparison module, and the guidance module are integrated in the binoculars.

According to another embodiment, the sensors, the processing module, the comparison module and the guidance module are integrated in the binoculars, and the geolocation module is integrated in a smartphone or tablet.

According to one embodiment, the guidance module is configured to generate an audible signal and/or a visual signal and/or a vibratory signal at least one characteristic of which is amplified when the difference calculated by the comparison module decreases.

Another aspect of the invention relates to a method for assisting the location of celestial objects, comprising the following steps: a) equipping binoculars comprising an optical system and a display module installed so as to display information in an image plane of said optical system, with at least one combination of sensors configured to measure horizontal coordinates of a celestial observation region, said combination of sensors comprising: at least one magnetometer, an accelerometer, and a gyroscope; b) determining position, date and observation-time data; c) determining equatorial celestial coordinates of the celestial observation region using the measurements from the combination of sensors and the data determined at the step; d) selecting a celestial object in a database containing selectable celestial objects associated with equatorial celestial coordinates; e) calculating a difference between the equatorial celestial coordinates determined at step c) and the celestial coordinates of the celestial object selected; f) generating a guidance signal at least one characteristic of which is dependent on the difference calculated at step e). The method furthermore comprises a step consisting in generating and/or selecting information to be displayed on the display module.

According to one embodiment, step a) consists in equipping the binoculars with several combinations of sensors and/or with a combination of sensors comprising at least two magnetometers; and step c) is implemented using the mean or the median of the magnetometer measurements.

According to one embodiment, the method furthermore comprises the following steps: automatically selecting in the database one or more celestial objects the equatorial celestial coordinates of which correspond to those determined at step c); generating and/or selecting information on said celestial object or objects selected; displaying said information on a display module.

According to one embodiment, the method furthermore comprises the following steps: c′) determining geographical coordinates of a terrestrial region using the measurements from the combination of sensors and the data determined at step b); d′) selecting a terrestrial reference point in a database containing selectable terrestrial reference points associated with geographical coordinates; e′) calculating a difference between the geographical coordinates determined at step c′) and the geographical coordinates of the terrestrial reference point selected; f) generating a guidance signal at least one characteristic of which is dependent on the difference calculated at step e′).

According to one embodiment, the method furthermore comprises the following calibration steps:—selecting a celestial object in a database containing celestial objects associated with equatorial celestial coordinates; said selected object having equatorial celestial coordinates corresponding to the equatorial celestial coordinates of the celestial observation region determined at step c); —displaying, on the display module, a digital image representing the celestial object selected, so that said digital image is perceived through an eyepiece of said binoculars; —fixing the digital image so that said image is displayed statically on the display module; —manually adjusting the binoculars to align the real image of the celestial object (perceived through the eyepiece of said binoculars) and the digital image; —finalizing the calibration as soon as the two images are superimposed and/or coincide.

Yet another aspect of the invention relates to a computer program comprising code instructions for executing the steps b), c), e) and f) of the aforementioned method, when said instructions are executed by a processing module.

### BRIEF DESCRIPTION OF THE FIGURES

Other advantages and features of the invention will emerge better from the reading of the description of following embodiments, with reference to the accompanying drawings, produced by way of indicative and non-limitative examples and on which:

FIG. 1 is an overall view of a device according to the invention.

FIG. 2A and FIG. 2B illustrate user interfaces for selecting a celestial object in a database.

FIG. 3 is a diagram illustrating the interaction of various elements of a device according to the invention and presenting various steps of a method according to the invention.

FIG. 4A and FIG. 4B show schematically example embodiments of a housing incorporating a set of sensors.

FIG. 5 is a simplified diagram of an optical system of binoculars in which a display module according to one embodiment is integrated.

FIG. 6 is a simplified diagram of an optical system of binoculars in which a display module according to another embodiment is integrated.

FIG. 7 illustrates steps of a method according to the invention for locating terrestrial reference points.

FIG. 8 illustrates the implementation of the calibration process during the observation of celestial objects (nocturnal calibration).

FIG. 9 illustrates the implementation of the calibration process during the observation of terrestrial objects (daytime calibration).

### DETAILED DESCRIPTION OF THE EMBODIMENTS

The invention can use one or more computer programs executed by equipment. For reasons of clarity, it must be understood, within the meaning of the invention, that ‘equipment does something’ or that ‘the computer program does something’ means ‘the computer program executed by a processing module of the equipment does something’.

Where applicable and to optionally supplement the normal definition thereof, the following clarifications are made to certain terms used in the claims and description:
‘Binoculars’ can be understood non-limitatively as a single binocular or a pair of binoculars.
‘Optical system’ can be understood as the assembly, organized and integrated in the binoculars, of optical components, such as optical lenses and prisms, designed to capture, direct and modify the light rays coming from an observation region in order to magnify the image perceived by the observer.
‘Computer resource’ can be understood non-limitatively as: components, hardware, software, file, connection to a computer network, quantity of RAM memory, hard-disk space, bandwidth, processor speed, number of CPUs, etc.
‘Processing module’ can be understood non-limitatively as: processor, microprocessors, CPU (standing for central processing unit).
‘Computer program’ can be understood as: software package, computer application, or software the code instructions are in particular executed by a processing module.
As used here, unless indicated to the contrary, any use of the ordinal adjectives ‘first’, ‘second’, etc. to describe an object or a step indicates simply that various occurrences of similar objects or steps are mentioned and does not mean that the objects or steps thus described must be in a given sequence, whether in time, in space, in a classification or in any other manner.
   ‘X and/or Y’ denotes: X alone or Y alone or X+Y.
In general terms, it will be appreciated that, on the various accompanying drawings, the objects are arbitrarily drawn to facilitate reading thereof.

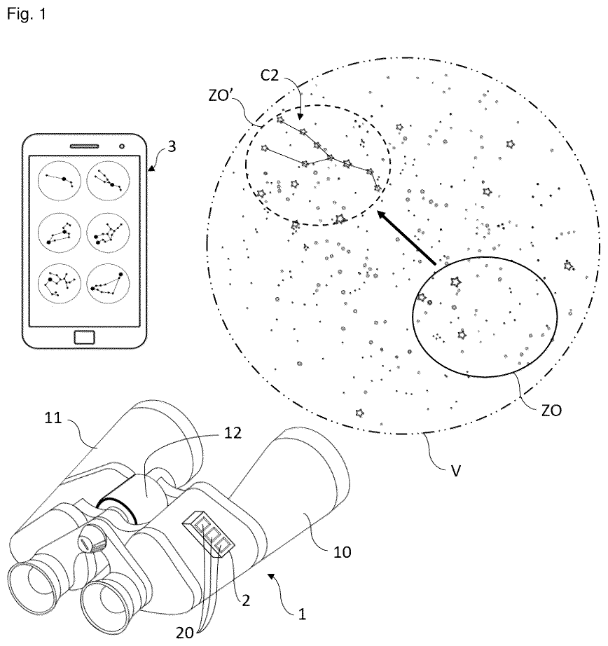

On the example in FIG. 1, the binoculars 1 are conventional commercial binoculars having two parallel optical tubes 10, 11, each being equipped with an eyepiece and one or more optical lenses and/or prisms forming the optical system. The two tubes 10, 11 are connected by a central bridge provided with a focusing mechanism 12, making it possible to adjust the sharpness of the image. The binoculars 1 can also include means for adjusting the inter-pupil distance in order to adapt to the morphology of each user.

Binoculars are typically classified by their magnification power and the diameter of their lenses. For example, in a pair of ‘8×42’ binoculars, the ‘8’ indicates a zoom factor (or magnification; proportional to the focal length) of 8 times, and the ‘42’ indicates an objective lens diameter of 42 mm.

According to one embodiment, the zoom factor of the binoculars 1 is between 2 and 20, preferentially greater than 8 for observing celestial objects. This zoom is preferentially fixed, but may be variable.

The binoculars 1 are equipped with one or more combinations of sensors 20 configured to measure horizontal coordinates of a region ZO observed through said binoculars.

On FIG. 1, the observation region ZO corresponds to a region of the celestial vault V. By way of example, the horizontal coordinates of the observation region ZO correspond to those of the centre of said region ±10%.

The system of horizontal coordinates makes it possible to locate celestial objects in the sky. This system uses azimuth and altitude measurements. Azimuth is the direction of a celestial object along the horizon, measured in degrees along the horizon from north to east. Altitude is the height of the celestial object above the horizon, measured in degrees. An object that is directly above the observer is at an altitude of 90 degrees.

According to one embodiment, the combination of sensors 20 comprises at least one magnetometer for measuring azimuth, an accelerometer the measuring altitude and a gyroscope for measuring rotation speed. This combination of sensors makes it possible to measure the horizontal coordinates precisely.

Measurement of azimuth by the magnetometer may be disturbed by surrounding metal masses. Thus the combination of magnetometer and gyroscope makes it possible to measure azimuth precisely and more reliably, in particular when the movement of the binoculars, measured by the gyroscope, is not consistent with the measurement of the magnetic field by the magnetometer.

To further improve the reliability of the magnetometer measurements, the combination of sensors 20 advantageously comprises at least two magnetometers, and/or several combinations of sensors are used as explained later in the description.

The celestial coordinates vary according to the position of the user on the Earth, the date, and the time. Consequently the device comprises a geolocation module 4 determining the position, the date, and the time of observation.

This geolocation module 4 is preferentially a GPS satellite geolocation module making it possible to obtain a precise and reliable measurement of the position, the date and the time of observation. Other types of satellite geolocation module of the GLONASS, BEIDOU or GALILEO type can however be used. Although less precise, it is also possible to use a module able to estimate the geographical position of the observer, the date and the time from data coming from mobile telephony network antennas and/or from Wi-Fi® access points.

According to one embodiment, the geolocation module 4 is a GPS module integrated in a conventional manner in a terminal 3 of the observer/user, in particular a smartphone, a tablet, or a portable computer. According to another embodiment, the geolocation module 4 is integrated in a housing 2 in which the sensors 20 are also installed.

The device also comprises a processing module 5 configured to determine equatorial celestial coordinates of the observation zone ZO using the measurements from the combination or combinations of sensors 20 and the data from the geolocation module 4. According to one embodiment, the processing module 5 is integrated in the housing 2. It may also be a case of a processing module integrated conventionally and natively in the terminal 3.

When the device comprises a plurality of magnetometers (either that the combination of sensors 20 comprises two or more magnetometers, or that several magnetometer/accelerometer/gyroscope combinations are used), then the mean or median of the measurements from said magnetometers is advantageously calculated by the processing module 5 to improve the precision of the measurements, while calling on few computational resources on the part of said processing module. The measurements by the magnetometers may in fact be affected by systematic or random errors or uncertainties such as their resolution, their precision, their stability over time (in particular with regard to changes in temperature or other parasitic environmental factors), noise, their linearity over the measurement range, etc. Averaging the measurements reduces the effect of these errors/uncertainties by compensating for them mutually. The median may however be less sensitive to the extreme values measured.

The measurements of azimuth are derived from the measurements of the intensity of the magnetic field measured by the magnetometer or magnetometers in two horizontal directions. These measurements may also be affected by the non-uniformity of the terrestrial magnetic field, due for example to local specificities (e.g.: geological structures) or to variations over time (e.g.: changes due to the movements of the liquid iron in the terrestrial core). Thus, according to one embodiment, the processing module 5 advantageously accesses a world magnetic module WMM (WMM being the English acronym of world magnetic model) representing the terrestrial magnetic field. The WMM is a standard model used for representing the terrestrial magnetic field. It is regularly updated to take account of slow but constant changes in the terrestrial magnetic field. This model supplies estimations of the magnetic field and the components thereof for various regions of the Earth, at various altitudes and in various time periods. The processing module 5 can thus apply corrections to the magnetometer measurements on the basis of information obtained from the WMM to calculate corrected measurements while taking account of local and temporal variations in the terrestrial magnetic field, as provided for by the WMM. These terrestrial measurements are then used for determining equatorial celestial coordinates of the observation region ZO. The data of the WMM model can for example be downloaded and stored in a memory area of the terminal 3 accessible to the processing module 5 or be accessible from a remote computer server to which said terminal 3 is connected.

According to one embodiment, the processing module 5 calculates the mean or median of the horizontal coordinates measured by all the sensors 20.

The number of magnetometers and/or of combinations of sensors (in the case where each combination comprises a single magnetometer) is between 1 and 10, this number advantageously being determined by the following formula:

N=c*(p*Z)²
where ‘N’ is the number of magnetometers and/or of combinations of sensors, N being an integer greater than or equal to 1, preferentially between 2 and 10, ‘c’ is a constant, ‘p’ is the precision of the magnetometer or magnetometers used and ‘n’ is the zoom factor of the binoculars 1.

This determination method makes it possible to have an excellent compromise between precision of the measurements and the number of sensors (and therefore cost). It is furthermore possible to very quickly and very easily select a suitable number of magnetometers and/or of combinations of sensors 20 according to the required precision level and the specifications of the binoculars 1, in particular the zoom factor thereof.

The system of equatorial celestial coordinates uses the measurements of right ascension and of declination. Right ascension is measured in hours, minutes and seconds from the vernal point. Declination is measured in degrees, minutes and seconds north and south of the celestial equator.

Converting the horizontal celestial coordinates (azimuth and altitude) into equatorial celestial coordinates (right ascension and detonation) requires knowledge of the precise location of the observer on the Earth and of the date and precise time of the observation.

The data supplied by the geolocation module 4 therefore also used by the processing module 5.

According to one embodiment, the conversion is done by the processing module 5 by executing the code instructions of a dedicated computer program such as SkyCoord® (class of the Astropy® library), NOVAS® (Naval Observatory Vector Astrometry Software), or Coordinate Converter®.

Advantageously, the processing module 5 takes the mean or the median of the real-time measurements of the combination or combinations of sensors 20 to determine the equatorial celestial coordinates of the observation region ZO. ‘Real time’ means, within the meaning of the invention, a frequency of calculation lying between one time and five times the acquisition frequency of the sensors 20. This thus gives real-time equatorial celestial coordinates of the observation region ZO, making location very precise and dynamic.

The device furthermore comprises a database of celestial objects with which equatorial celestial coordinates are associated. These equatorial celestial coordinates can be fixed or dynamic to take into account the time parameters for objects in movement (e.g.: comets, satellites, etc). According to a preferred embodiment, this database is integrated in a memory area of the terminal 3. The database may also be installed in a remote computer server to which the terminal 3 is connected. In any event, the database is accessible from the terminal 3, by launching a dedicated computer application previously downloaded into said terminal or accessible from an Internet site. This database can be regularly updated.

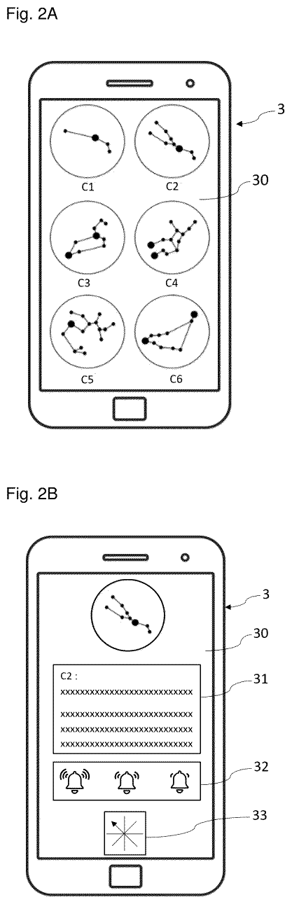

A user interface makes it possible to select a celestial object in this database. On FIGS. 2A and 2B, the user interface corresponds to a touch screen 30 of the terminal 3. The observer/user can for example seek a specific celestial object or navigate in a list of celestial objects C1-C6, and make a selection by touching the corresponding object on the touch screen. On the example of FIG. 2A, a list of constellations referenced C1 to C6 is displayed, appearing in the form of selectable pictograms.

By selecting one of these constellations, for example the constellation Taurus C2, the observer/user advantageously has access to information relating to this celestial object (for example its history and/or characteristics). On FIG. 2B, this information is displayed in a frame or a window 31 of the screen 30.

The device also comprises a comparison module 6 configured to compare the equatorial celestial coordinates of the observation region ZO determined by the processing module with the celestial coordinates associated with the selected celestial object C2. The comparison module can then calculate the difference between said coordinates. The comparison can in particular involve the subtraction of the coordinates to obtain this difference.

According to one embodiment, the comparison module 6 is in the form of a computer or a computer program executed by the processing module. The comparison module 6 is advantageously integrated in the terminal 3, but can be integrated in the housing 2.

The device also comprises a guidance module 7 generating a guidance signal, at least one characteristic of which is dependent on the difference calculated by the comparison module 6.

The guidance module 7 is integrated in the terminal 3, in the binoculars 1, or in the housing 2. According to one embodiment, the guidance module 7 is controlled by the processing module 5. The guidance module 7 can for example consist of a computer program executed by the processing module 5. The guidance signal generated is preferentially an audible signal (e.g.: audible pips, siren, melody) and/or a visual signal (e.g.: blinking screen or blinking LED, animated icon, color change) and/or a vibratory signal (e.g.: the terminal 3 or the housing 2 vibrates).

A multimode guidance signal combining several signaling modes and using various sensory modalities (vision, hearing, touch) makes it possible to maximize the probability that an observer/user detects, recognizes and responds to said signal, whatever the observation conditions and environment.

The variable characteristic or characteristics of the guidance signal can in particular be its frequency and/or its amplitude and/or its intensity and/or its tonality and/or its rhythm. For example, the greater the difference calculated by the comparison module 6, the lower will be the register of the audible guidance signal. Conversely, the closer the calculated difference is to zero, the more acute the audible guidance signal. According to another example, the vibration of the vibratory guidance signal intensifies when the difference calculated by the comparison module 6 decreases. In more general terms, at least one characteristic of the guidance signal is amplified when the difference calculated by the comparison module 6 decreases. When the difference calculated is zero or almost zero or, in more general terms, less than or equal to a predetermined threshold value (hereinafter referred to as ‘successful-location threshold value’), the guidance signal is then optimal.

On FIG. 2B, the guidance signal appears in a frame of window 32 of the screen 30. Another frame or window 33 can display a direction towards which to move the binoculars 1 to reach the region where the celestial object C2 is located. This indication may also be vocal. All this information constitutes the guidance signal.

The observer/user must thus move the binoculars 1 until the difference calculated by the comparison module 6 reaches the successful-location threshold value and the optimal guidance signal indicates the precise location of the region where the celestial object C2 is located. The invention therefore makes it possible to provide a clear indication of the successful detection of the region of the celestial object C2, which increases the speed, efficacy and precision of the observation process. Observing celestial objects thus becomes accessible to a large number of persons, in particular to observers/users who do not have profound knowledge or experience of astronomy.

According to one embodiment, the guidance module 7 is configured to generate the guidance signal only if the difference calculated by the comparison module is below or equal to a predetermined threshold value (hereinafter referred to as ‘guidance-triggering threshold value’). The guidance-triggering threshold value is higher than the successful-location threshold value. The guidance signal is thus generated only if the observed region ZO is not too distant from the object of interest C2. The observer/user is thus advised only if the object of interest C2 is in the field of vision of the binoculars 1 or in proximity thereto, which makes the search process more fun.

Thus, resuming the example of FIG. 1, the observer/user seeks the constellation Taurus C2. They initially point the binoculars towards an observation region ZO not containing this constellation. The initial observation region ZO being however relatively close to the constellation sought, the guidance signal is generated. The user interface can indicate in which direction to move the binoculars 1 (indication 33 on FIG. 2B). When the observation region contains the constellation (referenced ZO′), the guidance signal becomes optimal. The observer/user can now locate the constellation C2 through their binoculars 1.

In practical situations, once the observer/user has successively located the celestial object C2, the persistence of the guidance signal may prove to be annoying not only for themselves but also for other observers located close by. To mitigate this problem, the guidance module 7 is advantageously configured to interrupt the generation of the guidance signal when the difference calculated by the comparison module remains below or equal to a predetermined threshold value, for a predetermined period, for example between 5 seconds and 30 seconds. This smart control of the guidance module 7 not only improves the experience of the observer/user, but also minimizes disturbances for other observers present in the immediate environment thereof.

Alternatively or in addition, the device can comprise a button manually actuatable by the observer/user to interrupt the generation of the guidance signal. This button can for example be integrated in the binoculars 1 or on the housing 2, or be accessible from the terminal 3.

In some cases, even when the observer/user is observing the region of interest ZO′, the precise location of the object of interest C2 may prove to be complex for an amateur. It is thus advantageous to equip the binoculars 1 with a means for displaying information relating to the object of interest C2. This information, considered as aforementioned guidance signals, are generated and/or selected by the processing module 5 and can for example be in the form of one or more arrows, symbols or signaling elements indicating the location of the celestial object C2 and/or a geometric figure showing said object schematically. The processing module 5 can demand the display of this information in response to the selection of the celestial object C2 or in response to the generation of the guidance signal and/or as soon as the binoculars 1 are oriented towards the region of interest ZO′.

According to one embodiment, this display module is a screen located outside the binoculars 1, and may for example consist of the screen 30 of the terminal 3. An image of the region of interest ZO′, as viewable from the eyepieces of the binoculars 1, and wherein the aforementioned information reveal the object of interest C2, is then displayed on this screen. By consulting this display, the observer/user can locate the object of interest C2 more easily. This solution does however require turning their gaze away from the eyepieces to view the screen 30.

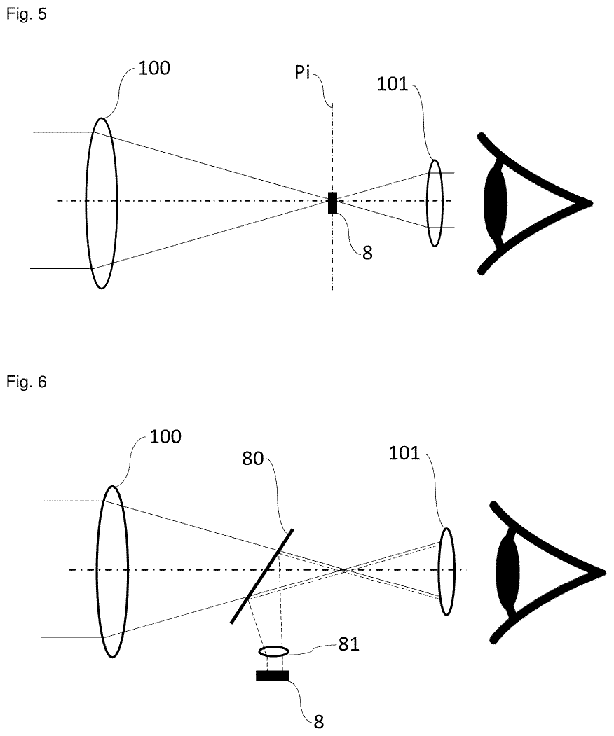

According to a variant embodiment illustrated on FIG. 5 and making it possible to improve the user experience, the display module 8 is integrated in the binoculars 1, and more particularly installed so as to display the information in an image plane Pi of the optical system. The image plane Pi is located at the point where the virtual image of the region being observed is formed by the lens 100 (the front lens) is projected before it is magnified by the eyepiece 101. The information displayed in the image plane Pi thus enables the observer/user to consult it while keeping their eyes at the eyepieces, without diverting their gaze.

According to one embodiment, this display module 8 is in the form of a screen, for example an OLED or LCD screen, installed in the image plane Pi so as to only partially obstruct the image being observed through the eyepiece 101.

According to another embodiment, this display module 8 is in the form of a semi-reflective screen, for example a liquid crystal film or a transparent OLED or LCD screen, installed in the image plane Pi so that the information displayed is superimposed on the real image being observed through the eyepiece 101. This solution makes it possible in particular to display the image of the object of interest C2 to the same scale as the real image of the celestial objects present in the observation region ZO, ZO′. The observer/user thus merely has to superimpose the two images to identify the object of interest C2.

According to another variant embodiment illustrated on FIG. 6, the display module 8 is in the form of a screen, for example an OLED or LCD screen, projecting a digital image of the information, in the direction of a semi-reflective plate 80. This plate 80 is arranged in the optical system so as to transmit to the eyepiece 101: a first subset of light rays coming from the region being observed (a natural image); and a second subset of light rays projected by the screen 8 (a digital image). These rays then combine at the eyepiece 101 to restore the natural image of the region being observed combined with the digital image of the information. A lens 81 is advantageously provided between the screen 8 and the semi-reflective plate 80 to orient and/or converge the light rays projected towards the plate.

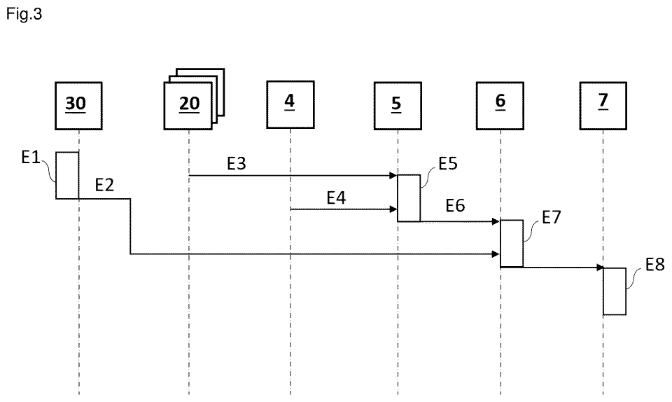

FIG. 3 illustrates an example of interaction of aforementioned various elements of the device and presents various steps of the method for assisting the location of celestial objects:
Step E1: from the interface 30, the observer/user selects a celestial object in the database.
Step E2: the equatorial celestial coordinates of the celestial object selected are transmitted to the comparison module 6. If the comparison module is integrated in the housing 2, this transmission can be implemented via a short-range communication line, for example of the Bluetooth® or Wi-Fi® type, established between said housing and the terminal 3. The housing 2 in this case incorporates the computer resources for providing this communication.
Step E3: the horizontal coordinates measured by the sensors 20 are transmitted to the processing module 5. If the processing module 5 is integrated in the terminal 3, this transmission can be implemented via a short-range communication line, for example of the Bluetooth® or Wi-Fi® type, established between the housing 2 and said terminal. The housing 2 in this case incorporates the computer resources for providing this communication.
Step E4: the position, date and time data determined by the geolocation module 4 are transmitted to the processing module 5. If the geolocation module 4 and the processing module 5 are not installed in the same equipment (housing 2 or terminal 3), this transmission can be implemented via a short-range communication line, as described previously.
Step E5: the processing module 5 determines the equatorial celestial coordinates of the celestial observation region ZO using the measurements from the sensors 20 and the data from the geolocation module 4.
Step E6: the equatorial celestial data determined by the processing module 5 are transmitted to the comparison module 6. If the processing module 5 and the comparison module 6 are not installed in the same equipment (housing 2 or terminal 3), this transmission can be implemented via a short-range communication line, as described previously.
Step E7: the comparison module 6 makes the comparison of the equatorial celestial coordinates transmitted by the processing module 5 with the celestial coordinates transmitted at step E2.
Step E8: the guidance module 7 generates the guidance signal according to the results of the comparison of step E7.

According to one embodiment, the geolocation module 4, the processing module 5, the comparison module 6, and the guidance model 7 are integrated in the terminal 3. The device thus benefits from the computer resources that are normally natively present in a terminal 3 of the smartphone or tablet type, so that the size, design, and costs of the housing 2 are limited. The technology offered by the invention is thus accessible to a larger number of users. The sensors 20 can also be installed in the terminal 3. In this case, the terminal 3 is preferentially attached to the binoculars 1 so that the horizontal coordinates of the region ZO observed through said binoculars are reliable and precise.

According to a variant embodiment, the binoculars 1 are equipped with some of the modules, the rest of the modules being integrated in the terminal 3.

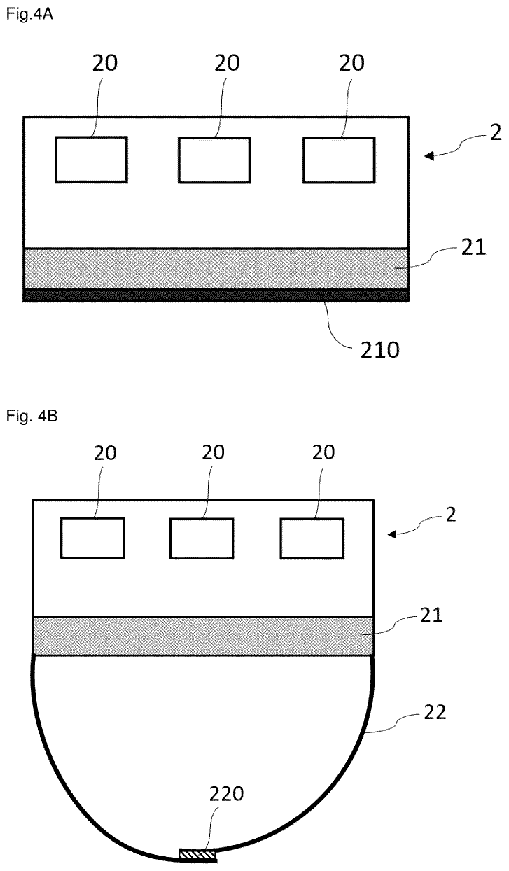

On FIGS. 4A and 4B, the sensors 20 are housed in a housing 2 designed to be mounted on the binoculars 1. The housing 2 has for example a length of between 10 mm and 60 mm, a width between 5 mm and 20 mm and a height of between 2 mm and 5 mm. These dimensions make it possible to guarantee a good compromise between a compactness that is not a problem for the observer/user and harmonious integration.

The housing 2 is advantageously watertight to provide protection against bad weather and rigid to withstand potential impacts. It can be produced from plastics material, steel, aluminum, composite, or other similar material and be obtained by molding, machining, assembly, etc.

Inside the housing 2, each sensor 20 can be installed in an individual arrangement or attached to a common support, in particular on a common electronic card.

The housing 2 is preferentially adapted to be attached in a stable manner to the binoculars 1, thus avoiding any undesirable movements of said housing during observation, while easily being adaptable to various models of binoculars.

An external face of the housing 2 is preferentially provided with a pad 21. This pad can be glued or screwed to the external face of the housing 2. It is formed from a supple and/or flexible material, for example from elastomer of the rubber type, enabling it to conform to various shapes and/or finishings of the binoculars to ensure optimal securing.

In the embodiment in FIG. 4A, the pad 21 is designed to be attached detachably to the binoculars 1. The face of the pad 21 intended to be attached to the binoculars 1 can in particular be provided with an adhesive covering 210 enabling it to be removed without leaving residues, for example a silicone-based glue, a hot-melt adhesive or a dual-face adhesive, with peelable protective strip. According to a variant embodiment, the pad 21 is designed to be permanently attached to the binoculars 1, for example by means of a glue of the cyanoacrylate or epoxy type.

In the embodiment in FIG. 4B, the housing 2 is an equipped with a fastener or strap 22 provided with an adjustable attachment means 220, for example of the Velcro® type, allowing rapid adjustment. The strap 22 allows modular attachment and easy detachment.

The fastener or strap 22 is preferentially elastic to allow adaptable fastening to various models of binoculars. The elastic strap 22, once stretched around the binoculars 1, provides stable attachment of the housing 2. One advantage of this solution is its ability to adapt to various sizes and shapes of binoculars.

In this embodiment with strap 22, the pad 21 is not necessary although it improves stability and adaptability.

Other detachable attachment methods can also be envisaged. For example, a clip or rail system can be incorporated on the housing 2, enabling it to be clipped or mounted on a complementary support of the binoculars 1. If the binoculars 1 have metal components or a dedicated magnetic support, the housing 2 can incorporate magnets. The housing 2 can also comprise mini-suckers. Threaded inserts can also be added to the binoculars 1, the housing then being directly screwed onto said insets.

According to another embodiment, the sensors 20 are integrated in the structure of the binoculars 1, for example when the latter are designed.

According to one embodiment, the geolocation module 4, the processing module 5, the comparison module 6, and the guidance module 7 are also integrated in the housing 2.

According to yet another aspect, the invention relates to a computer program product comprising code instructions for executing at least the steps for determining the position, the date and the observation time; transforming the horizontal coordinates into equatorial celestial coordinates; comparing the equatorial celestial coordinates thus calculated with the celestial coordinates associated with the celestial object selected; calculating the difference between said coordinates; and generating the guidance signal, when the program is executed by a processing module, in particular the processing module of the terminal 3. The program thus provides a software implementation of the method, which can be executed on a variety of devices, in particular a smartphone, with updates that can be simple.

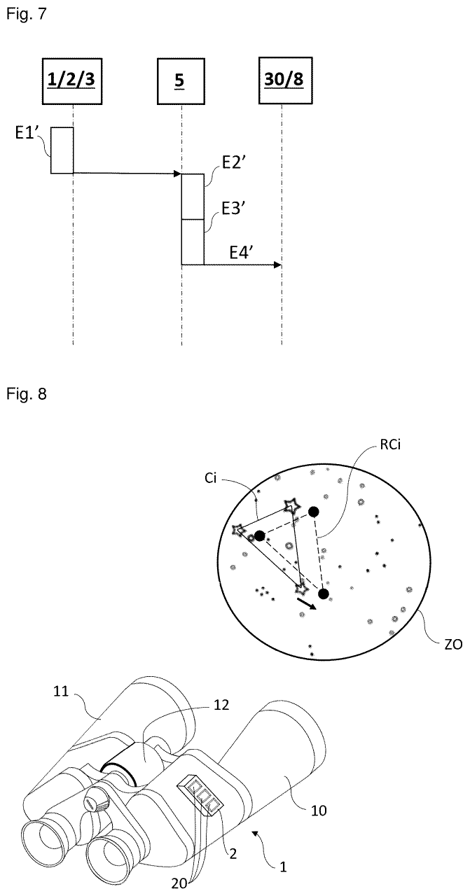

Another functionality makes it possible not to guide the observer/user to an object of interest, but to indicate one or more objects of interest in a celestial region ZO that they are in the process of observing. For example, the observer/user observes a celestial region ZO, sees an object, and wishes to identify it. The various steps allowing this identification (FIG. 7) are advantageously as follows:
Step E1′: the observer/user selects this functionality, for example by actuating a dedicated button integrated in the binoculars 1 or on the housing 2, or accessible from the terminal 3.
Step E2′: the processing module 5 determines the equatorial celestial coordinates of the observation region using the measurements from the sensors 20 and the data from the geolocation module 4 (aforementioned step E5).
Step E3′: the processing module 5 automatically selects in the database the celestial object or objects the equatorial celestial coordinates of which correspond to those measured.
Step E4′: the processing module 5 generates and/or selects information on the object or objects of interest and demands display thereof on the aforementioned display module 30, 8.

According to an additional functionality, the device can be used in the same manner, but for locating terrestrial location points such as mountain peaks, valleys, villages, rivers, lakes, forests or other natural or artificial location points observable with binoculars. In this case, the geographical coordinates (latitude, longitude, and altitude) of the terrestrial location points are used. The database associates reference terrestrial location points with the geographical coordinates thereof. The method can be as follows: the observer/user selects a terrestrial location point in the database; the processing module 5 determines the geographical coordinates of the observer/user and of the terrestrial observation region using the measurements from the sensors 20 and the data from the geolocation module 4. The comparison module 6 calculates a difference between the geographical coordinates determined by the processing module 5 and the geographical coordinates of the location point selected; the guidance module 7 generates a guidance signal at least one characteristic of which is dependent on the difference calculated by the comparison module 6. Knowing the geographical coordinates of the observer/user and the geographical coordinates of the location point, the processing module 5 can in particular deduce and indicate the direction in which the binoculars must be inclined (alt/az coordinates) to aim at the selected location point.

The sensors 20 and/or the geolocation module 4 may be subject to imprecision or disturbances caused by various factors, in particular electromagnetic interferences (proximity of metal objects, parasitic magnetic fields), poor GPS reception, or intrinsic measurement errors. These disturbances may compromise the precision of the coordinates determined by the processing module 5, and thus impair the match between the real vision of the user and the precision of the guidance signal and/or the precision of the displayed data. In order to guarantee reliable and precise celestial guidance and location, it is advantageous to incorporate prior calibration of the sensors 20 and/or of the geolocation module 4.

This calibration may be initiated manually by the observer/user, for example by actuating a dedicated button located on the binoculars 1 or the housing 2, or via the interface of the terminal 3. This calibration may also be initiated automatically by the processing module 5, for example as soon as said module detects that the binoculars 1 remain oriented towards the observation region ZO for a predetermined period (e.g.: 5 s or 10 s).

Once the calibration is activated, the processing module 5 determines the equatorial celestial coordinates of the observation zone ZO by relying on the data supplied by the sensors 20 and the geolocation module 4.

Next, the processing module 5 selects, in the database, one or more previously recorded celestial objects the equatorial celestial coordinates of which correspond to those of the observation region ZO.

The processing module 5 generates and/or selects a digital representation—or digital image—of this celestial object and demands display thereof on the display module 8 integrated in the binoculars 1.

For example, as illustrated in FIG. 8, the processing module 5 identifies the celestial object Ci the equatorial coordinates of which correspond to those of the celestial observation region ZO. It generates and/or selects a digital image RCi of this celestial object Ci and displays it on the display module 8. The observer/user thus simultaneously perceives through the eyepieces: the real image of the celestial object Ci and the digital image RCi thereof.

However, because of the potential disturbances and/or imprecision of the sensor 20 and/or of the geolocation module 4, there may be a spatial offset between the real image of the celestial object Ci and the digital image RCi thereof. This offset may result in an absence of exact superimposition, or in instability phenomena (e.g.: shaking or erratic shifts of the digital image).

In order to improve the stability of the digital image RCi and to allow precise adjustment, the processing module 5 fixes said digital image RCi so that it is displayed statically on the display module 8. This fixing can be implemented automatically by the processing module 5 when instability is detected, or be initiated manually by the observer/user by actuating a dedicated button located on the binoculars 1 or on the housing 2 mounted thereon. Whatever the manner of initiating the fixing of the image RCi, the observer/user can keep their eyes on the eyepieces, without diverting their gaze, and keeping the binoculars 1 oriented towards the celestial observation region ZO.

Once the digital image RCi is fixed, the observer/user manually adjusts the binoculars 1 in order to align the real image of the celestial object Ci with their fixed digital image RCi. In other words, it is the real image that is moved.

As soon as the two images are superimposed and/or coincide, the observer/user can confirm the completion of the calibration process by activating the aforementioned button.

This validation enables the processing module 5 to apply a correction to the initial measurement errors, thus improving the overall precision of the coordinates for the subsequent observations.

This calibration process makes it possible to reliably and robustly correct the initial measurement errors of the sensor 20 and/or of the geolocation module 4. By means of the static fixing of the digital image, this calibration guarantees optimal visual stability, avoiding any shaking or erratic shifting. In addition, the absence of incessant recalculations also reduces calibration errors, in particular those due to disturbances or unwanted movements of the binoculars 1. Moreover, the manual and intuitive alignment of the real image and fixed digital image makes it possible to improve the user experience, without having to manipulate complex adjustments.

This calibration process is technically independent of the generation of the guidance signal. In particular, this process can be implemented without the user interface 30, without the comparison module 6, and without the guidance module 7. It can be applied to numerous observation devices, such as binoculars, astronomy glasses, augmented reality headsets, etc.

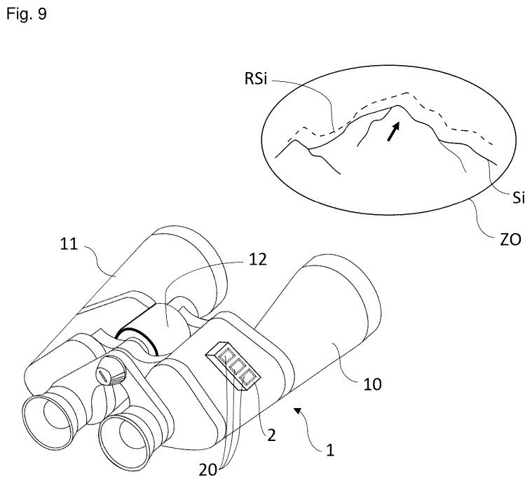

FIG. 9 illustrates another example of application of this calibration process to a device used for locating terrestrial location points. After having determined the geographical coordinates of the observation region ZO, the processing module 5 selects, in the database, one or more previously recorded terrestrial objects the geographical coordinates of which correspond to those of the observation region ZO. The processing module 5 here selects one or more ridge lines of a mountain the geographical coordinates of which correspond to those of the zone ZO. It generates and/or selects a digital image RSI of this ridge line and displays it on the display module 8. The observer/user thus simultaneously perceives, through the eyepieces: the real image Si of the mountain and the digital image RSi of the ridge line thereof. Once the digital image RSi is fixed, the observer/user physically adjusts the binoculars 1 in order to align the real image of the terrestrial object Si with said fixed digital image. As soon as the two images coincide (alignment of the real ridge line with the digital ridge line), the calibration process is complete.

The arrangement of the different elements and/or means and/or steps of the invention, in the embodiment described above, should not be understood as requiring such an arrangement in all the implementations. In any case, it will be understood that various modifications may be made to these elements and/or means and/or steps, without deviating from the spirit and the scope of the invention.

Furthermore, one or more features described only in one embodiment can be combined with one or more further features described only in a further embodiment. Similarly, one or more features described only in one embodiment may be generalized to the other embodiments, even if this or these features are described only in combination with other features.

1. A device for assisting location determination of celestial objects, comprising:
binoculars comprising an optical system and a display module installed so as to display information in an image plane of said optical system, said binoculars being equipped with at least one combination of sensors configured to measure horizontal coordinates of a celestial observation region, said combination of sensors comprising: at least one magnetometer, an accelerometer, and a gyroscope;
a geolocation module for determining position, date, and observation-time data;
processing module for determining equatorial celestial coordinates of the celestial observation region using the measurements from the combination of sensors and the data from the geolocation module, said processing module being configured to generate and/or select information to be displayed on the display module;
a database containing equatorial celestial coordinates of selectable celestial objects;
a user interface for selecting a celestial object in the database;
a comparison module for calculating a difference between the equatorial celestial coordinates determined by the processing module and the celestial coordinates of the celestial object selected; and
a guidance module for generating a guidance signal at least one characteristic of which is dependent on the difference calculated by the comparison module.

2. The device according to claim 1, wherein the combination of sensors comprises at least two magnetometers.

3. The device according to claim 1, wherein the binoculars are equipped with several combinations of sensors.

4. The device according to claim 2, wherein the measurements from the combination of sensors used for determining the equatorial celestial coordinates of the celestial observation region comprise the mean or the median of the magnetometer measurements.

5. The device according to claim 3, wherein the measurements from the combinations of sensors used for determining the equatorial celestial coordinates of the celestial observation region comprise a mean or median of the magnetometer measurements.

6. The device according to claim 1, wherein the processing module is configured to take a mean or median of the real-time measurements of the combination of sensors to determine the equatorial celestial coordinates of the celestial observation region.

7. The device according to claim 1, wherein the processing module is configured to:
a) receive measurements from the magnetometer;
b) access a world magnetic model representing the terrestrial magnetic field;
c) apply corrections to the measurements from the magnetometer on the basis of the information obtained from the world magnetic model to calculate corrected measurements; and
d) use the corrected measurements to determine the equatorial celestial coordinates of the celestial observation region.

8. The device according to claim 1, wherein the display module is a screen installed in the image plane so as to only partly obstruct the image of the celestial observation region observed through an eyepiece of the optical system.

9. The device according to claim 1, wherein the display module is a semi-reflective screen installed in the image plane so that the information displayed is superimposed on the image of the celestial observation region observed through an eyepiece of the optical system.

10. The device according to claim 1, wherein the display module is a screen projecting a digital image of the information in the direction of a semi-reflective plate, said plate being arranged in the optical system so that said digital image is superimposed on the image of the celestial observation region observed through an eyepiece of said optical system.

11. The device according to claim 1, wherein the guidance module is configured to generate the guidance signal if the difference calculated is less than or equal to a first predetermined threshold value.

12. The device according to claim 1, wherein the guidance module is configured to cease the generation of the guidance signal when the difference calculated by the comparison module remains below or equal to a second predetermined threshold value during a predetermined period.

13. The device according to claim 1, wherein the sensors are housed in a housing designed to be mounted on the binoculars.

14. The device according to claim 1, wherein the geolocation module, the processing module, the comparison module, and the guidance module are integrated in a smartphone or a tablet.

15. The device according to claim 1, wherein the sensors, the geolocation module, the processing module, the comparison module, and the guidance module are integrated in the binoculars.

16. The device according to claim 1, wherein the sensors, the processing module, the comparison module and the guidance module are integrated in the binoculars, and the geolocation module is integrated in a smartphone or tablet.

17. The device according to claim 1, wherein the guidance module is configured to generate an audible signal and/or a visual signal and/or a vibratory signal at least one characteristic of which is amplified when the difference calculated by the comparison module decreases.

18. A method for assisting determination of location of celestial objects, comprising the following steps:
a) equipping binoculars comprising an optical system and a display module, with at least one combination of sensors configured to measure horizontal coordinates of a celestial observation region, said combination of sensors comprising: at least one magnetometer, an accelerometer, and a gyroscope
b) determining position, date and observation-time data;
c) determining equatorial celestial coordinates of the celestial observation region using the measurements from the combination of sensors and the data determined at step b);
d) selecting a celestial object in a database containing selectable celestial objects associated with equatorial celestial coordinates;
e) calculating a difference between the equatorial celestial coordinates determined at step c) and the celestial coordinates of the celestial object selected;
f) generating a guidance signal at least one characteristic of which is dependent on the difference calculated at step e); and
said method furthermore comprising a step consisting in generating and/or selecting information to be displayed on the display module.

19. The method according to claim 18, wherein
step a) comprises equipping the binoculars with several combinations of sensors and/or a combination of sensors comprising at least two magnetometers, and
step c) is implemented using the mean or the median of the measurements from the magnetometers of several combinations of sensors and/or of the combination of sensors comprising at least two magnetometers.

20. The method according to claim 18, further comprising the following steps:
automatically selecting in the database one or more celestial objects the equatorial celestial coordinates of which correspond to those determined at step c),
generating and/or selecting information on said celestial object or objects selected, and
displaying said information on the display module.

21. The method according to claim 18, further comprising the following steps:
c′) determining geographical coordinates of a terrestrial region using the measurements from the combination of sensors and the data determined at step b);
d′) selecting a terrestrial reference point in a database containing selectable terrestrial reference points associated with geographical coordinates;
e′) calculating a difference between the geographical coordinates determined at step c′) and the geographical coordinates of the terrestrial reference point selected; and
f) generating a guidance signal at least one characteristic of which is dependent on the difference calculated at step e′).

22. The method according to claim 18, further comprising the following calibration steps:
selecting a celestial object in a database containing celestial objects associated with equatorial celestial coordinates, said selected object having equatorial celestial coordinates corresponding to the equatorial celestial coordinates of the celestial observation region determined at step c);
displaying, on the display module, a digital image representing the celestial object selected, so that said digital image is perceived through an eyepiece of said binoculars;
fixing the digital image so that said image is displayed statically on the display module;
manually adjusting the binoculars to align the real image of the celestial object perceived through the eyepiece of said binoculars and the digital image; and
finalizing the calibration as soon as the two images are superimposed and/or coincide.

23. A computer program comprising code instructions for executing the steps b), c), e) and f) of the method according to claim 18, when said instructions are executed by a processing module.
